(19) United States
(12) Patent Application Publication
(10) Pub. No.: US 2026/0113233 A1
(43) Pub. Date: Apr. 23, 2026

(54) METHODS AND PROCEDURES FOR PPDU PADDING, SPATIAL STREAM PARSING, AND SEGMENT PARSING WITH UNEQUAL MODULATION

(71) Applicant: InterDigital Patent Holdings, Inc., Wilmington, DE (US)

(72) Inventors: Ying WANG, Easton, PA (US); Hanqing Lou, Syosset, NY (US); Rui Yang, Greenlawn, NY (US); Mahmoud Saad, Montreal (CA)

(73) Assignee: InterDigital Patent Holdings, Inc., Wilmington, DE (US)

(21) Appl. No.: 18/921,959

(22) Filed: Oct. 21, 2024

(51) Int. Cl. H04L 27/34; H04L 5/00

(52) U.S. Cl. CPC H04L 27/3483; H04L 5/0092; H04L 5/0007

(57) ABSTRACT

Procedures apply to unequal modulation over spatial streams. A station (STA) may determine, for each of a plurality of spatial streams, an associated modulation order, wherein a first spatial stream has an associated modulation order with a one-dimensional (1D) constellation and a second spatial stream has an associated modulation order with a two-dimensional (2D) constellation. The STA may parse a bit sequence corresponding to an OFDM symbol into the plurality of spatial streams by iteratively allocating, in round robin order for a number of iterations, a respective number of consecutive bits of the OFDM symbol to each of the plurality of spatial streams according to the associated modulation orders and not allocating any bits to the first spatial stream in every second iteration of the round robin order. The STA may transmit the plurality of spatial streams in a plurality of frequency subblocks associated with the plurality of spatial streams.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is peer-to-peer traffic, which may also be sent directly between the source and destination STAs with a direct link setup (DLS) using an 802.11e DLS or an 802.11z tunneled DLS (TDLS). A WLAN using Independent BSS (IBSS) mode has no AP, and the STAs using such an IBSS may communicate directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels are formed by combining contiguous 20 MHz channels as described above for 802.11n. A 160 MHz channel may be formed either by combining 8 contiguous 20 MHz channels, or by combining two non-contiguous 80 MHz channels, which may be referred to as an 80+80 configuration. For the 80+80 configuration, at the transmitter, the data, after channel encoding, may be passed through a segment parser that divides the data into two streams. Inverse fast Fourier transform (IFFT) and time domain processing are done on each stream separately. The two streams are then mapped onto the two 80 MHz channels for transmission. At the receiver, this mechanism is reversed, and the combined data from the two 80 MHz channels is sent to the medium access control (MAC) layer.

In 802.11ax, High Efficiency (HE) Wireless STAs may support 20 MHz, 40 MHz, 80 MHz, and/or 160 MHz wide channels capable of transmission over 2.4 GHZ, 5 GHZ, and 6 GHz frequency bands using both orthogonal frequency-division multiple access (OFDMA) and multi-user multiple-input multiple-output (MU-MIMO) capabilities. OFDMA subcarrier modulation in HE STAs includes formats such as BPSK, QPSK, 16-QAM, 64-QAM, 256-QAM, and 1024-QAM. The evolution of 802.11 to Extremely High Throughput (EHT, or 802.11be) STAs extends to having 320 MHz wide channels.

Sub 1 GHz modes of operation are supported by 802.11af and 802.11ah. For these specifications the channel operating bandwidths, and the number of Orthogonal frequency-division multiplexing (OFDM) subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel is therefore limited by the STA that supports the smallest bandwidth operating mode in the BSS. In the example of 802.11ah, the primary channel may be 1 MHz wide if there are STAs (e.g. MTC type devices) that only support a 1 MHz mode even if the AP, and other STAs in the BSS, may support 2 MHz, 4 MHz, 8 MHz, 16 MHz, or other channel bandwidth operating modes. All carrier sensing and NAV settings depend on the status of the primary channel, i.e., if the primary channel is busy, for example, due to a STA supporting only a 1 MHz operating mode is transmitting to the AP, then the entire available frequency bands are considered busy even though majority of it stays idle and available.

To improve spectral efficiency, 802.11n introduced multiple-input multiple-output (MIMO) technology, which multiplies capacity by transmitting up to four data streams (or spatial streams) over different antennas. 802.11ac further introduced downlink multi-user MIMO (MU-MIMO) transmission, where multiple users may send their data streams (max 4 per user, total up to 8) over different antennas simultaneously on the same frequency, i.e., on the same OFDM subcarrier and in the same OFDM symbol. 802.11ax and 802.11be use both orthogonal frequency-division multiple access (OFDMA), which is multiplexing users in the frequency domain, and UL/DL MU-MIMO, which is multiplexing users in the spatial domain.

The IEEE 802.11 Ultra High Reliability (UHR), or 802.11bn, Study Group was formed in September 2022. UHR is considered as the next major revision to IEEE 802.11 standards following 802.11be (or EHT), which is currently in the Working Group Letter Ballot Stage. UHR explores the possibility to improve reliability, support further reduced low latency traffic, further increase peak throughput, improve power saving capabilities, and improve efficiency of the IEEE 802.11 network over EHT.

### SUMMARY

Methods and procedures are disclosed herein for applying unequal modulation over spatial streams. A station (STA) may determine, for each spatial stream of a plurality of spatial streams, an associated modulation order, wherein a first spatial stream of the plurality of spatial streams has an associated modulation order with a one-dimensional (1D) constellation and a second spatial stream of the plurality of spatial streams has an associated modulation order with a two-dimensional (2D) constellation. The STA may parse a bit sequence corresponding to an OFDM symbol into the plurality of spatial streams by iteratively allocating, in round robin order for a number of iterations, a respective number of consecutive bits of the OFDM symbol to each of the plurality of spatial streams according to the associated modulation orders and not allocating any bits to the first spatial stream in every second iteration of the round robin order. The STA may transmit the plurality of spatial streams in a plurality of frequency subblocks associated with the plurality of spatial streams.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram illustrating an example transmitter for transmitting a data field of an extremely high throughput (EHT) single user (SU) transmission in a resource unit (RU) or multiple resource unit (MRU);

FIG. 2B is a system diagram illustrating an example parser subsystem, including stream parser and segment parsers, that may be part of a transmitter such as example transmitter in FIG. 2A;

FIG. 3 is a system diagram illustrating an example parser subsystem including a stream parser for UEQM across spatial streams, where all of the spatial streams have modulation schemes with two-dimensional (2D) constellation;

FIG. 4 is a system diagram illustrating an example parser subsystem including a stream parser for UEQM across spatial streams, where the spatial streams have modulation schemes with one-dimensional (1D) and 2D constellations;

FIG. 5 is a system diagram illustrating another example parser subsystem including a stream parser for UEQM across spatial streams, where the spatial streams have modulation schemes with 1D and 2D constellations;

FIG. 6 is a system diagram illustrating another example parser subsystem including a stream parser for UEQM across spatial streams, where the spatial streams have modulation schemes with 1D and 2D constellations;

FIG. 7 is a flow diagram illustrating an example procedure for parsing a bit stream for unequal modulation over spatial streams including modulations schemes with 1D and 2D constellations; and

FIG. 8 is a frame format diagram illustrating an example PPDU format illustrating the EHT PPDU bit padding process.

### DETAILED DESCRIPTION

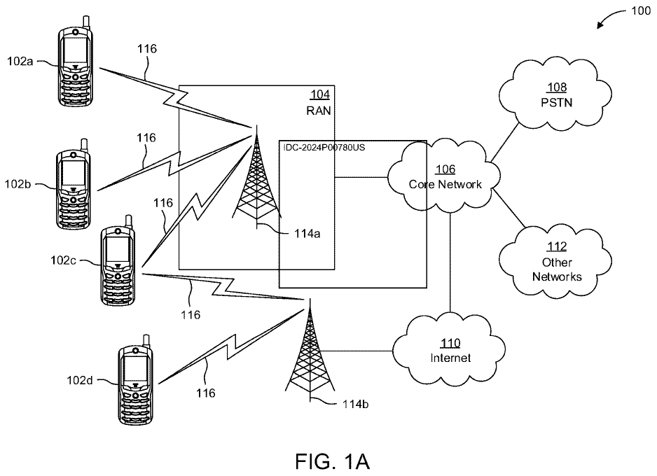

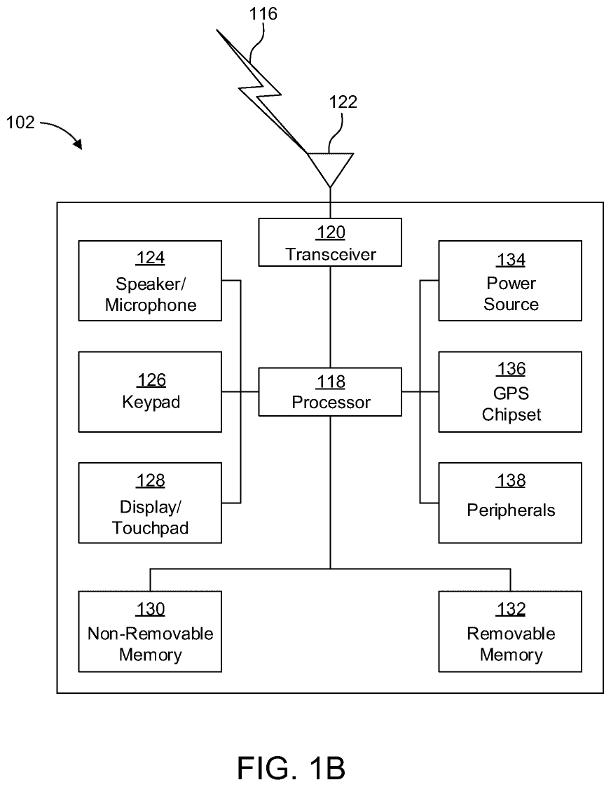

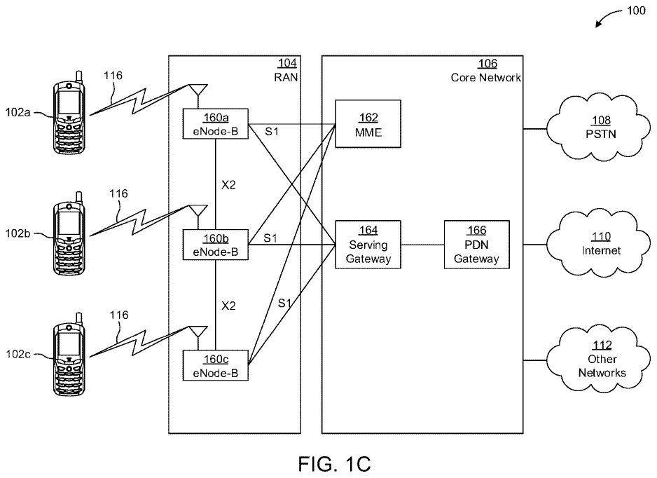

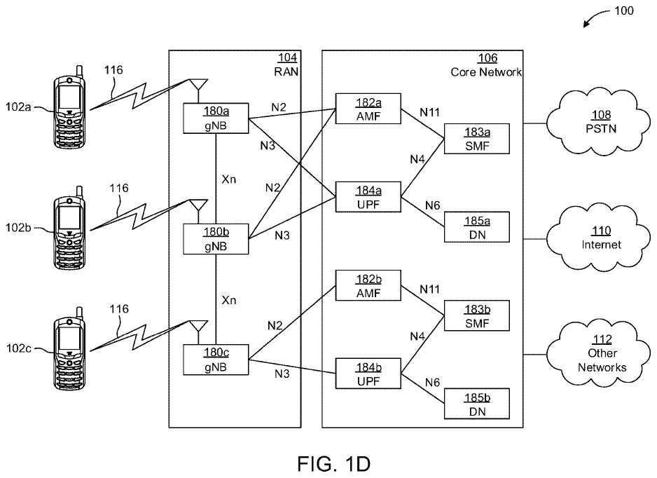

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi (WiFi) radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAS extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

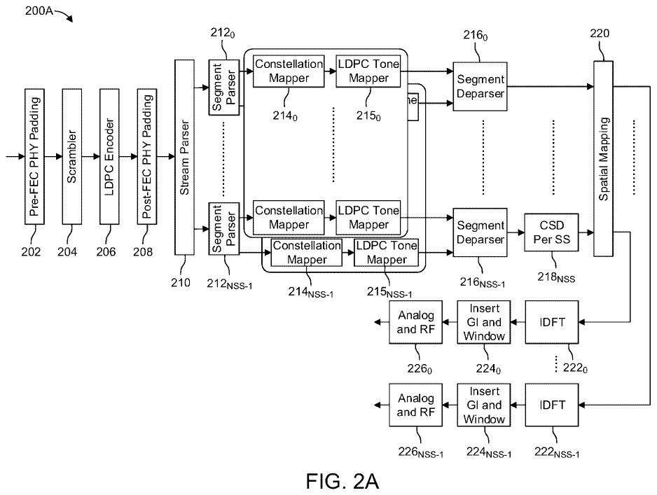

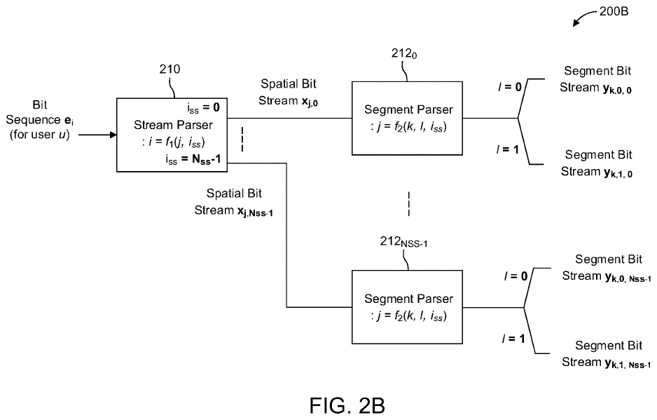

For MIMO transmission in 802.11be, the data bit streams or sequences at the output of the forward error correction (FEC) encoders may be parsed by stream parsers and/or segment parsers into streams or blocks of bits to get the bits ready to be mapped to constellation points in spatial streams on subcarriers, as shown for example in FIG. 2A. FIG. 2A is a system diagram illustrating an example transmitter 200A (e.g., a transceiver) for transmitting a data field of an extremely high throughput (EHT) single user (SU) transmission in a resource unit (RU) or multiple resource unit (MRU). The RU or MRU may have a size same or larger than a 996-tone RU with low-density parity-check code (LDPC) encoding. Pre-FEC physical (PHY) layer padding unit 202 ensures the correct number of input bits to the low-density parity check (LDPC) encoder 206. Scrambler 204 scrambles the input data bits to reduce the probability of long sequences of ‘0’s or ‘1’s. LDPC encoder 206 encodes the data bits to enable error correction using LDPC encoding. Post-FEC PHY Padding unit 208 adds padding bits to the data bits ensure that the total number of bits will fill in whole OFDM symbols. Stream parser 210 may rearrange input bits into Nₛₛ blocks of bits, with each block of bits corresponding to a spatial stream (Nₛₛ is the number of spatial streams). The bits of each spatial stream may be further parsed by segment parsers 212₀, . . . , 212_{Nss-1}, which rearranges the input bits for transmission over frequency subblocks (e.g., 80 MHz frequency subblocks). The purpose of the stream parser 210 and segment parsers 212₀, . . . , 212_{Nss-1} is to avoid bursty block errors in the encoded bits by not having too many consecutive encoded bits to go through the same channel conditions (i.e., the same spatial stream and/or the same frequency subblock).

Bits in each frequency subblock of each spatial stream are mapped to a QAM constellation point sequence on the data tones by constellation mappers 214₀, . . . , 214_{Nss-1}. LDPC tone mappers 215₀, . . . , 215_{Nss-1} is to permute this constellation point sequence to different tones. Segment deparsers 216₀, . . . , 216_{Nss-1} merge 80 MHz frequency subblocks back into one frequency segment. Cyclic Shift Diversity (CSD) per SS unit 218_{Nss} applies CSD to each spatial stream. Spatial mapping unit 220 applies a spatial mapping matrix to map the vector of Nss complex numbers in each subcarrier into a vector of N_{TX} complex numbers in each subcarrier, where N_{TX} is the number of transmit antennas. Inverse discrete Fourier transform (IDTF) units 222₀, . . . , 222_{Nss-1} compute the ITDF of the input signals. Insert guard interval (GI) and window units 224₀, . . . , 224_{Nss-1} prepend a predetermined guard interval and apply windowing to generate an OFDM symbol. Analog and radio frequency (RF) units 226₀, . . . , 226_{Nss-1} upconvert the resulting complex baseband waveform with each transmit chain to an RF signal according to the center frequency of the desired channel and transmit. The spatial streams may be transmitted over data tones of one or more respective RUs of the frequency subblocks of the spatial streams.

Because different spatial streams and different frequency subblocks may experience different channel conditions, such as the effects of multipath fading and interference, one way to improve the throughput is to use higher modulation orders in the spatial steams or frequency subblocks that have higher signal-to-noise ratio (SNR) or signal-to-interference-and-noise ratio (SINR), and vice versa. In the case of MU, this is partially accomplished for MU-MIMO where different users may occupy different spatial streams and for OFDMA where different users may occupy different frequency subblocks, and different users may use different modulations. However, for a single user (SU), even though 802.11n originally supported unequal modulation (UEQM) over different spatial streams, UEQM over spatial streams disappeared from subsequent 802.11 amendments. UEQM over frequency subblocks for an SU was never implemented in prior 802.11 standards.

To further improve efficiency and increase throughputs, 802.11bn is introducing UEQM over spatial streams back into the WiFi standards. In future standards, UEQM over frequency may be defined for better adaptation to the channel variations across frequency. In an example, the frequency granularity may be 80 MHz subblocks. In this case, the modulation order remains the same within each 80 MHz subblock and the modulation order may be different for different 80 MHz subblocks (without excluding 80 MHz subblocks having the same modulation order). In another example, a smaller frequency granularity may be RUs or data tones within 80 MHz subblocks, such that the modulation order may be different across RUs or data tones within a frequency subblock (e.g., within an 80 MHz subblock). The selection of the UEQM frequency granularity may depend on the channel variation across the frequency domain and may involve a trade-off between the throughput gain and the implementation complexity.

Regardless of the frequency granularity, a stream parser should take UEQM into account and allocate bits accordingly corresponding to the number of constellation points for the RUs or frequency blocks of each spatial stream. A segment parser is then needed to allocate bits accordingly so that each subcarrier is allocated the correct number of bits for its assigned modulation order. When UEQM over both spatial streams and frequency subblocks are simultaneously defined, a combined stream/segment parser may be used.

For the example embodiments described herein, a “frequency subblock” may refer for example to an 80 MHz frequency subblock for illustrative purposes, however frequency subblock may be any other frequency width including, but not limited to, 320 MHz, 160 MHz, 40 MHz, or 20 MHz, or may be any resource unit (RU) or other defined frequency segment.

The example embodiments described herein are described in terms of an SU transmission. For MU transmissions, the rearrangements are carried out in the same way per user. For example, a subscript u for a given user u may be added to any of the equations disclosed herein to distinguish between different users. Herein, tone and subcarrier may be used interchangeably, and data tone and data subcarrier may be used interchangeably. An X-tone RU may have a total number of X tones, including both data tones and pilot tones. When a data bit sequence is assigned to a RU, the bits may be allocated to the data tones (i.e., data subcarriers) only.

For example embodiments described herein, it may be assumed that the given user u has Nₛₛ spatial streams and L frequency segments. FIG. 2B is a system diagram illustrating an example parser subsystem 200B, including stream parser 210 and segment parsers 212₀, . . . , 212_{Nss-1}, that may be part of a transmitter such as example transmitter 200A in FIG. 2A. For a given user u, an encoded bit sequence {eᵢ}, i=0, 1, . . . , N_{CBPS}−1 corresponding to one OFDM symbol may be provided as input to stream parser 210 then segment parsers 212₀, . . . , 212_{Nss-1} (stream parser 210 and segment parsers 212₀, . . . , 212_{Nss-1} may be a combined ins a single combination parser), where N_{CBPS} is the number of coded bits per OFDM symbol. The spatial bit stream or sequence in spatial stream iₛₛ is denoted by {x_{j,i}_{ₛₛ}}, j=0, 1, . . . , N_{CBPSS,i}_{ₛₛ}−1, where N_{CBPSS,i}_{ₛₛ} is the number of coded bits per OFDM symbol for spatial stream iₛₛ and

$${N}_{CBPS} = {\sum }_{{i}_{s s} = 0}^{{N}_{s s} - 1} {N}_{CBPSS , {i}_{ss}} .$$

The segment bit stream or sequence of frequency segment l in spatial stream iₛₛ is denoted by {y_{k,l,i}_{ₛₛ}}, k=0, 1, . . . , N_{CBPS,l,i}_{ₛₛ}−1, l=0, 1, . . . . L−1, where N_{CBPSS,l,i}_{ₛₛ} is the number of coded bits per OFDM symbol in frequency segment l for spatial stream iₛₛ, L is the number of frequency segments (L=2 in the example of FIG. 2B) and

$${N}_{CBPSS , {i}_{ss}} = {\sum }_{l = 0}^{L - 1} {N}_{CBPSS , l , {i}_{ss}} .$$

When the stream parser and the segment parser are separable, there may be a mapping function ƒ₁(⋅) implemented in stream parser 210 between the indexes of bit sequences {eᵢ} and {x_{j,i}_{ₛₛ}} such that i=ƒ₁(j, iₛₛ), and another mapping function ƒ2(⋅) implemented in each of segment parsers 212₁, . . . , 212_{Nss} between the indexes of bit sequences {x_{j,i}_{ₛₛ}} and {y_{k,l,i}_{ₛₛ}} such that j=ƒ₂(k, l, iₛₛ). In an example not shown where the stream parser 210 and the segment parsers 212₁, . . . , 212_{Nss} are combined, a combined mapping function ƒ(⋅) between the bit indexes of sequences {eᵢ} and {y_{k,l,i}_{ₛₛ}} is applicable such that i=ƒ(k, l, iₛₛ).

Example embodiments of applying unequal modulation across the spatial streams and over different frequency subblocks, or resource units (RUs), or multiple resource units (MRUs) are described hereinafter. Example embodiments of UEQM over spatial streams and/or at a finer frequency granularity of RUs within 80 MHz frequency subblocks are described hereinafter.

In an example embodiment, for a given user u and Nₛₛ spatial streams, it may be assumed that different modulation sizes are allowed across spatial streams and within each spatial steam the modulation size is the same across frequency subblocks, RUs, or MRUs. In this case, a stream parser and a segment parser may be separately applied to assign bits to spatial stream and frequency resources.

N_{CBPS} is the number of bits in coded bit sequence {eᵢ}. The coded bit sequence {eᵢ}, i=0, 1, . . . , N_{CBPS}−1 is provided as input to the stream parser and the N_{CBPS} bits may be rearranged into Nₛₛ blocks of bits, each block of bits for a spatial stream having N_{CBPSS,i}_{ₛₛ} bits, where N_{CBPSS,i}_{ₛₛ} is the number of coded bits per OFDM symbol for spatial stream iₛₛ.

As described above, OFDMA subcarrier modulation for 802.11 STAs includes formats that convey different number of bits, such as: binary phase shift keying (BPSK) (one bit), quadrature phase sift keying (QPSK) (two bits), 16-quadrature amplitude modulation (16-QAM) (four bits), 64-QAM (six bits), 256-QAM (eight bits), 1024-QAM (ten bits), and 4096-QAM (twelve bits). These modulation schemes can be represented on a constellation diagram by showing points positioned in the complex plane having a real axis (horizontal or in-phase axis) and an imaginary axis (vertical or quadrature axis). BPSK is a type of phase-shift keying (PSK) modulation for which the constellation points only exist on the real (horizontal) axis and do not have an imaginary component on the imaginary (vertical) axis. For this reason, BPSK is a type of one-dimensional (1D) modulation and is a modulation scheme with a 1D constellation. When referred to herein, a modulation scheme with a 1D constellation may refer to BPSK or any type of 1D modulation. Moreover, BPSK is used as an example for the embodiments herein, and is interchangeable with any other type of 1D modulation (e.g., a modulation for which the constellation points only exist on the imaginary axis). In contrast, a modulation order/scheme with a two-dimensional (2D) constellation has constellation points with a real component and an imaginary component in the complex plane (e.g., QPSK, 16-QAM, 64-QAM, 256-QAM, 1024-QAM, or 4096-QAM etc.).

In a first example of UEQM across spatial streams, it is assumed that all of the spatial streams have 2D modulation (e.g., QPSK, 16-QAM etc.). In other words, none of the spatial streams have 1D modulation (e.g., BPSK). According to an example embodiment, the number of bits assigned to a single axis (real or imaginary) in a constellation point in spatial stream iₛₛ is denoted by

$${s}_{{i}_{ss}} = max ( 1 , \frac{{N}_{BPSCS , {i}_{ss}}}{2} ) ,$$

where iₛₛ=0, 1, . . . , Nₛₛ−1 and N_{BPSCS,i}_{ₛₛ} is the number of coded bits per subcarrier for spatial stream iₛₛ. The number of assigned bits over all spatial streams is

$$S = {\sum }_{{i}_{s s} = 0}^{{N}_{s s} - 1} {s}_{{i}_{ss}} .$$

Blocks of S consecutive bits of bit sequence {eᵢ} are assigned to Nₛₛ spatial streams in a round robin order, such that sᵢ_{ₛₛ} consecutive bits are assigned or allocated to spatial stream iₛₛ for iₛₛ from 0 to Nₛₛ−1 with each round robin iteration. That is, bit with index i of the input bit sequence {eᵢ} (the index refers to the bit's position in the bit sequence) is assigned to a bit with index j of the output bit sequence {x_{j,i}_{ₛₛ}} at spatial stream iₛₛ, where i is a function of iₛₛ and j, and the mapping function is expressed as x_{j,i}_{ₛₛ}=eᵢ where

$$i = S \cdot ⌊ \frac{j}{{s}_{{i}_{ss}}} ⌋ + {\sum }_{k = 0}^{{i}_{s s} - 1} {s}_{k} + j mod {s}_{{i}_{ss}} \qquad ( 1 )$$

$$for {i}_{ss} = 0 , 1 , … , {N}_{ss} - 1 ,$$

$$i = 0 , 1 , … , {N}_{CBPS} - 1 , and$$

$$j = 0 , 1 , … , {N}_{CBPSS , {i}_{ss}} - 1.$$

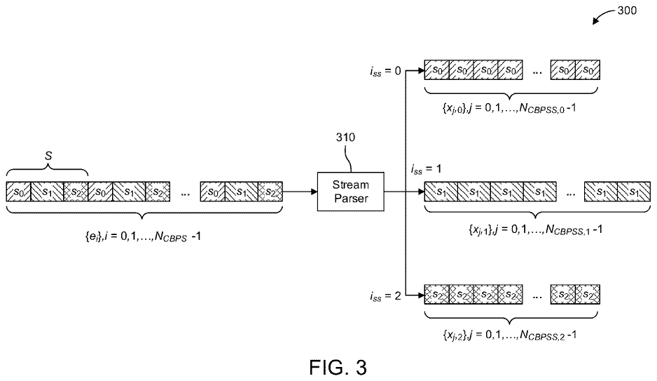

FIG. 3 is a system diagram illustrating an example parser subsystem 300 including stream parser 310 for UEQM across spatial streams, where all of the spatial streams have modulation schemes with 2D constellation. The stream parser 310 allocates input bits {eᵢ}, i=0, 1, . . . , N_{CBPS}−1 for UEQM to the output bit sequence {x_{j,i}_{ₛₛ}} according to i=ƒ₁(j, iₛₛ) over the spatial streams iₛₛ=0, 1, 2 for j=0, 1, . . . , N_{CBPSS,i}_{ₛₛ}−1, where N_{CBPSS,i}_{ₛₛ} is the number of coded bits per OFDM symbol for spatial stream iₛₛ. Because the modulation order of all subcarriers within a spatial stream iₛₛ is the same, the stream parser may for example use a round robin approach for assigning bits to spatial streams iₛₛ=0, 1, 2 without considering how each spatial stream further maps bits to subcarriers. A segment parser (not shown) may further assign the N_{BPSCS,i}_{ₛₛ} bits in spatial stream iₛₛ=0,1, . . . , Nₛₛ−1 to different (e.g., 80 MHz) frequency subblocks (and the RUs or MRUs of the frequency subblocks).

In the examples of UEQM across spatial streams described hereinafter, it is assumed that at least one spatial stream uses 1D modulation (e.g., BPSK). In an example, when a first spatial stream iₛₛ=0 uses a modulation scheme with a 1D constellation such as BPSK modulation, the number of consecutive bits assigned to the spatial stream iₛₛ=0 is sᵢₛ=N_{BPSCS,i}_{ₛₛ}=1. In contrast, a second spatial stream iₛₛ=1 with modulation order higher than BPSK (e.g., QPSK, 16QAM etc.) and thus a 2D constellation has the number consecutive bits assigned to the spatial stream iₛₛ=1 as sᵢ_{ₛₛ}=N_{BPSCS,i}_{ₛₛ}/2. If the round-robin process is as described in Equation (1), the spatial stream iₛₛ=0 with the BPSK modulation would get all their bits assigned first while other spatial streams only get half their bits assigned. To avoid this imbalance, an example solution is not to allow BPSK modulation for spatial streams when UEQM across spatial streams is enabled, such that the stream parser may allocate bits to spatial streams according to Equation (1). Example procedures for the stream parser to allocate bits into spatial streams are described hereinafter for the cases where BPSK (or any modulation scheme with a 1D constellation) is used in UEQM across spatial streams. In examples herein, BPSK modulation is used to refer to a modulation order with a 1D constellation for illustrative purposes.

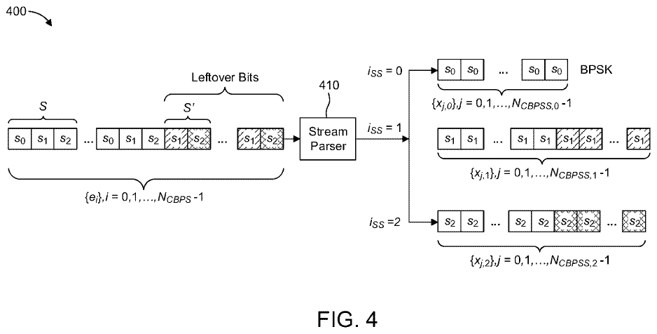

According to an example procedure for allocating bits (i.e., parsing a bit sequence) to spatial streams with UEQM across spatial streams including modulations schemes with 1D and 2D constellations, consecutive bits are allocated to the spatial streams in round-robin order (similar to the round robin order described hereinbefore) until all the spatial streams with BPSK modulation (1D constellation) obtain their assigned bits N_{CBPSS,i}_{ₛₛ}. The remaining spatial streams with higher order modulation than BPSK modulation, and thus a 2D constellation, are allocated leftover input bits in {eᵢ} according to a round-robin process until all bits are allocated to spatial streams (i.e., only the remaining spatial stream(s) iₛₛ with higher order modulation than BPSK are allocated respective consecutive sᵢ_{ₛₛ} bits in the remaining iterations of the round robin process). This example procedure is illustrated in FIG. 4.

FIG. 4 is a system diagram illustrating an example parser subsystem 400 including stream parser 410 for UEQM across spatial streams, where the spatial streams have modulation schemes with 1D and 2D constellations. The stream parser 410 uses a modified round robin process to handle BPSK modulation in the first spatial stream iₛₛ=0 and higher modulation with 2D constellations in the other spatial streams iₛₛ=1 and iₛₛ=2. Although one spatial stream iₛₛ=0 is shown as having BPSK, the example parsing procedure applies for multiple spatial stream iₛₛ=0 using BPSK modulation. Similarly, although two spatial streams iₛₛ=1 and iₛₛ=2 are shown as having higher order modulation, the example parsing procedure applies for any number of spatial streams with higher order modulation (one, two, or more).

As used by the stream parser 410, bit with index i of the input bit sequence {eᵢ} is assigned to a bit with index j of the output bit sequence {x_{j,i}_{ₛₛ}} at spatial stream iₛₛ, where i is a function of iₛₛ and j, according to the mapping function x_{j,i}_{ₛₛ}=eᵢ where

$$i = \{ \begin{matrix}S \cdot ⌊ \frac{j}{{s}_{{i}_{ss}}} ⌋ + {\sum }_{k = 0}^{{i}_{s s} - 1} {s}_{k} + j mod {s}_{{i}_{ss}} , if \frac{j}{{s}_{{i}_{ss}}} < {N}_{SD} \\ S \cdot {N}_{SD} + {S}^{′} \cdot ⌊ \frac{{j}^{′}}{{s}_{{i}_{ss}}} ⌋ + {\sum }_{k = 0}^{{i}_{s s} - 1} {s}_{k} \cdot I ( {N}_{BPSCS , {i}_{ss}} > 1 ) + \\ {j}^{′} mod {s}_{{i}_{ss}} , if {N}_{SD} \leq \frac{j}{{s}_{{i}_{ss}}} < 2 {N}_{SD}\end{matrix} \qquad ( 2 )$$

$$for {i}_{ss} = 0 , 1 , … , {N}_{ss} - 1 ,$$

$$i = 0 , 1 , … , {N}_{CBPS} - 1 ,$$

$$j = 0 , 1 , … , {N}_{CBPSS , {i}_{ss}} - 1 ,$$

such that

$$S = {\sum }_{{i}_{s s} = 0}^{{N}_{s s} - 1} {s}_{{i}_{ss}} , {S}^{′} = {\sum }_{{i}_{s s} = 0}^{{N}_{s s} - 1} {s}_{{i}_{ss}} \cdot I ( {N}_{B P S C S , {i}_{s s}} > 1 ) ,$$

$${N}_{SD} = {N}_{CBPSS , {i}_{s s}} / {N}_{BPSCS , {i}_{s s}}$$

is the number of effective data tones carrying unique data per symbol, j′=j−sᵢ_{ₛₛ}. N_{SD}, and I(N_{BPSCS,i}_{ₛₛ}>1) is an indicator function of whether the modulation order on spatial stream iₛₛ is larger than BPSK or not. In this example, I(N_{BPSCS,i}_{ₛₛ}>1) equals to 1 when N_{BPSCS,i}_{ₛₛ}>1 is true (i.e., the modulation order is higher than BPSK), and I(N_{BPSCS,i}_{ₛₛ}>1) equals to 0 otherwise. S, S′ each represent a total number of bits assigned in a round-robin round to the corresponding spatial stream.

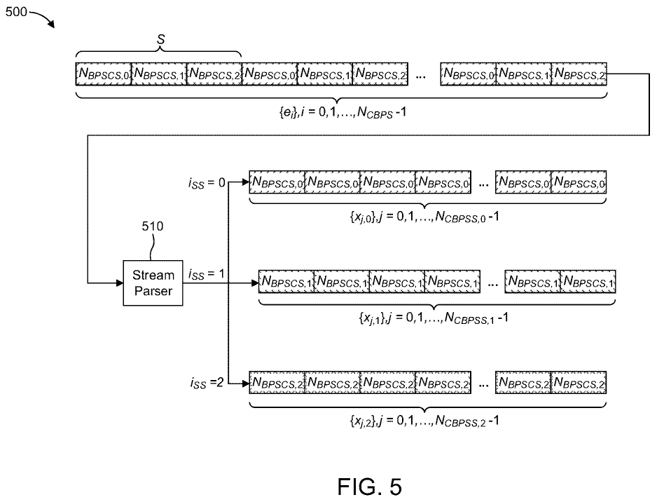

According to another example procedure for allocating bits (i.e., parsing a bit sequence) to spatial streams with UEQM across spatial streams including modulations schemes with 1D and 2D constellations, a stream parser may allocate N_{BPSCS,i}_{ₛₛ} consecutive bits (N_{BPSCS,i}_{ₛₛ} is the number of coded bits per subcarrier for spatial stream iₛₛ) to each respective spatial stream iₛₛ in each round-robin round or iteration. This example procedure is illustrated in FIG. 5. FIG. 5 is a system diagram illustrating an example parser subsystem 500 including stream parser 510 for UEQM across spatial streams, where the spatial streams have modulation schemes with 1D and 2D constellations. In this example, any of the spatial streams iₛₛ=0, iₛₛ=1, and iₛₛ=2, may have BPSK modulation and/or any other order of modulation. As used by the stream parser 510, bit with index i of the input bit sequence {eᵢ} is assigned to a bit with index j of the output bit sequence {x_{j,i}_{ₛₛ}} at spatial stream iₛₛ, where i is a function of iₛₛ and j, according to the mapping function x_{j,i}_{ₛₛ}=eᵢ where

$$i = {S}^{″} \cdot ⌊ \frac{j}{{N}_{BPSCS , {i}_{s s}}} ⌋ + {\sum }_{k = 0}^{{i}_{s s} - 1} {N}_{BPSCS , k} + j mod {N}_{BPSCS , {i}_{ss}} \qquad ( 3 )$$

$$for {i}_{s s} = 0 , 1 , … , {N}_{s s} - 1 ,$$

$$i = 0 , 1 , … , {N}_{CBPS} - 1 ,$$

$$j = 0 , 1 , … , {N}_{CBPSS , {i}_{ss}} - 1 ,$$

$$such that {S}^{″} = {\sum }_{{i}_{s s} = 0}^{{N}_{s s} - 1} {N}_{BPSCS , {i}_{ss}} .$$

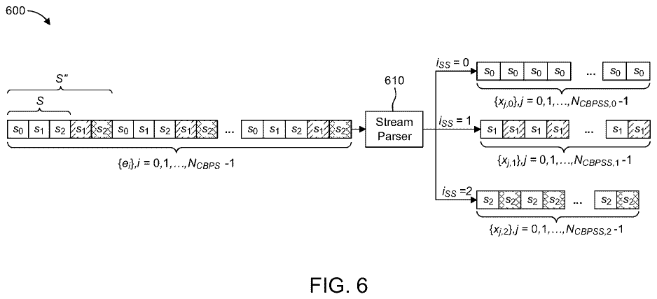

According to another example procedure for allocating bits (i.e., parsing a bit sequence) to spatial streams with UEQM across spatial streams including modulations schemes with 1D and 2D constellations, a stream parser may assign sᵢ_{ₛₛ} consecutive bits to spatial stream iₛₛ in a round-robin fashion, and may skip assigning bits to the spatial stream(s) with BPSK modulation in every other round or iteration of the round robin. For example, the spatial stream(s) with BPSK modulation may not be assigned bits in every odd round of the round robin (e.g., the starting round may be considered an even round) and may only be assigned sᵢ_{ₛₛ} consecutive bits in every even round of the round robin, or vice versa. This example procedure is illustrated in FIG. 6.

FIG. 6 is a system diagram illustrating an example parser subsystem 600 including stream parser 610 for UEQM across spatial streams, where the spatial streams have modulation schemes with 1D and 2D constellations. In this example, spatial stream iₛₛ=0 has BPSK modulation (i.e., a modulation scheme with a 1D constellation) and spatial streams iₛₛ=1 and iₛₛ=2 have higher modulations than BPSK (i.e., modulation schemes with 2D constellations). In the round robin allocation of consecutive bits to spatial streams, spatial stream iₛₛ=0 is skipped in the odd rounds of the round robin. As used by the stream parser 610, bit with index i of the input bit sequence {eᵢ} is assigned to a bit with index j of the output bit sequence {x_{j,i}_{ₛₛ}} at spatial stream iₛₛ, where i is a function of iₛₛ and j, according to the mapping function x_{j,i}_{ₛₛ}=eᵢ where

$$i = \{ \begin{matrix}{S}^{″} \cdot ⌊ \frac{j}{{N}_{BPSCS , {i}_{ss}}} ⌋ + {\sum }_{k = 0}^{{i}_{s s} - 1} {s}_{k} + j mod {s}_{{i}_{ss}} , \\ if ( j mod {N}_{BPSCS , {i}_{ss}} ) < {s}_{{i}_{ss}} \\ {S}^{″} \cdot ⌊ \frac{j}{{N}_{BPSCS , {i}_{ss}}} ⌋ + S + {\sum }_{k = 0}^{{i}_{s s} - 1} {s}_{k} \cdot I ( {N}_{BPSCS , {i}_{ss}} > 1 ) + \\ j mod {s}_{{i}_{ss}} , if ( j mod {N}_{BPSCS , {i}_{ss}} ) \geq {s}_{{i}_{ss}}\end{matrix} \qquad ( 4 )$$

$$for {i}_{s s} = 0 , 1 , … , {N}_{s s} - 1$$

$$i = 0 , 1 , … , {N}_{CBPS} - 1 ,$$

$$j = 0 , 1 , … , {N}_{CBPSS , {i}_{ss}} - 1 ,$$

$$such that {S}^{″} = {\sum }_{{i}_{s s} = 0}^{{N}_{s s} - 1} {N}_{BPSCS , {i}_{ss}} ,$$

$$S = {\sum }_{{i}_{s s} = 0}^{{N}_{s s} - 1} {s}_{{i}_{ss}} ,$$

and I(N_{BPSCS,i}_{ₛₛ}>1) is an indicator function of whether the modulation order on spatial stream iₛₛ is larger than BPSK or not. In this example, I(N_{BPSCS,i}_{ₛₛ}>1) equals to 1 when N_{BPSCS,i}_{ₛₛ}>1 is true (i.e., the modulation order is higher than BPSK), and I(N_{BPSCS,i}_{ₛₛ}>1) equals to 0 otherwise. S, S″ each represent a total number of bits assigned in a round-robin round to the corresponding spatial stream.

Alternatively, in the round robin allocation of consecutive bits to spatial streams, spatial stream iₛₛ=0 is skipped in the even rounds of the round robin. As used by the stream parser 610, bit with index i of the input bit sequence {eᵢ} is assigned to a bit with index j of the output bit sequence {x_{j,i}_{ₛₛ}} at spatial stream iₛₛ, where i is a function of iₛₛ and j, according to the mapping function x_{j,i}_{ₛₛ}=eᵢ where

$$i = \{ \begin{matrix}{S}^{″} \cdot ⌊ \frac{j}{{N}_{BPSCS , {i}_{ss}}} ⌋ + {\sum }_{k = 0}^{{i}_{s s} - 1} {s}_{k} \cdot I ( {N}_{BPSCS , {i}_{ss}} > 1 ) + \\ j mod {s}_{{i}_{ss}} , if ( j mod {N}_{BPSCS , {i}_{ss}} ) < {s}_{{i}_{ss}} \\ {S}^{″} \cdot ⌊ \frac{j}{{N}_{BPSCS , {i}_{ss}}} ⌋ + {\sum }_{k = 0}^{{N}_{s s} - 1} {s}_{k} \cdot I ( {N}_{BPSCS , {i}_{ss}} > 1 ) + {\sum }_{k = 0}^{{i}_{s s} - 1} {s}_{k} + \\ j mod {s}_{{i}_{ss}} , if ( j mod {N}_{BPSCS , {i}_{ss}} ) \geq {s}_{{i}_{ss}}\end{matrix} \qquad ( 5 )$$

$$for {i}_{s s} = 0 , 1 , … , {N}_{s s} - 1$$

$$i = 0 , 1 , … , {N}_{CBPS} - 1 ,$$

$$j = 0 , 1 , … , {N}_{CBPSS , {i}_{ss}} - 1 ,$$

$$such that {S}^{″} = {\sum }_{{i}_{s s} = 0}^{{N}_{s s} - 1} {N}_{BPSCS , {i}_{ss}} ,$$

and I(N_{BPSCS,i}_{ₛₛ}>1) is an indicator function of whether the modulation order on spatial stream iₛₛ is larger than BPSK or not. In this example, I(N_{BPSCS,i}_{ₛₛ}>1) equals to 1 when N_{BPSCS,i}_{ₛₛ}>1 is true (i.e., the modulation order is higher than BPSK), and I(N_{BPSCS,i}_{ₛₛ}>1) equals to 0 otherwise.

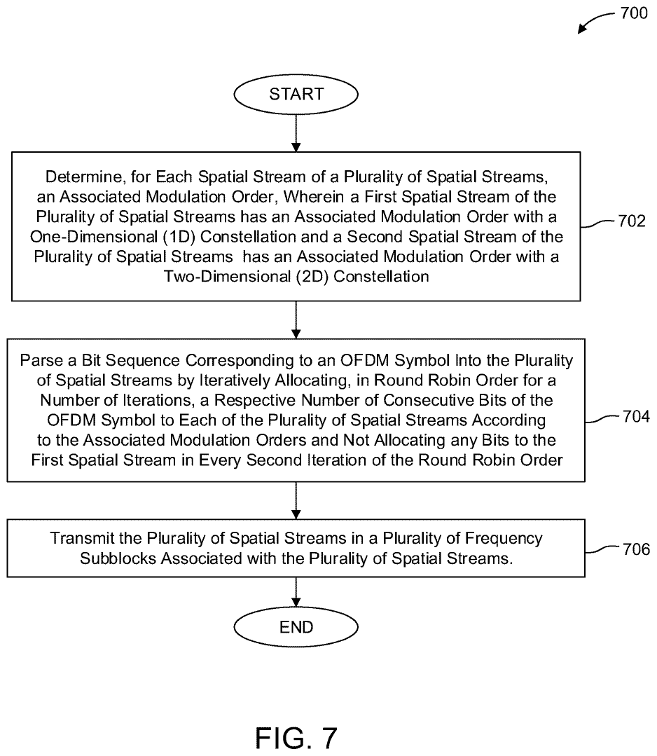

FIG. 7 is a flow diagram illustrating an example procedure 700 for parsing a bit stream for unequal modulation over spatial streams including modulations schemes with 1D and 2D constellations. Example procedure 700 may be performed by a stream parser that is part of a transmitter (transceiver), and the transmitter (transceiver) may be part of a STA (e.g., an AP, a non-AP STA, a WTRU). Example procedure 700 may correspond to the parser subsystem 600 in FIG. 6. With reference to procedure 700 of FIG. 7, at 702, the STA may determine, for each spatial stream of a plurality of spatial streams, an associated modulation order, wherein a first spatial stream (or two or more) of the plurality of spatial streams has an associated modulation order with a one-dimensional (1D) constellation and a second spatial stream (or two or more) of the plurality of spatial streams has an associated modulation order with a two-dimensional (2D) constellation. At 704, the STA may parse a bit sequence corresponding to an OFDM symbol into the plurality of spatial streams by iteratively allocating, in round robin order for a number of iterations, a respective number of consecutive bits of the OFDM symbol to each of the plurality of spatial streams according to the associated modulation orders and not allocating any bits to the first spatial stream (or two or more spatial streams with BPSK modulation) in every second iteration of the round robin order. At 706, the STA may transmit the plurality of spatial streams in a plurality of frequency subblocks associated with the plurality of spatial streams.

The plurality of frequency subblocks comprise one or more resource units (RUs), and the one or more RUs comprises data tones, wherein the bits allocated to each of the plurality of the spatial streams are mapped to constellation point sequences on the data tones. For example, the plurality of frequency subblocks are 20 MHz, 40 MHz, 80 MHz, or 160 MHz wide. In an example, the associated modulation order of the first spatial stream of the plurality of spatial streams is binary phase shift keying (BPSK) and the 1D constellation is on a real axis in a complex plane. The associated modulation order of the second spatial stream of the plurality of spatial streams is one of: quadrature phase sift keying (QPSK), 16-quadrature amplitude modulation (16-QAM), 64-QAM, 256-QAM, 1024-QAM, or 4096-QAM. The 2D constellation of the associated modulation order of the second spatial stream of the plurality of spatial streams has constellation points with a real component and an imaginary component.

Example procedures may be used for UEQM over frequency (i.e., UEQM in the frequency domain). In an example, UEQM may be applied to MRUs within 80 MHz Frequency Subblocks. If UEQM is allowed within 80 MHz frequency subblocks on the RU level, a segment parser is further needed for 52+26-, 106+26-, 484+242-tone MRUs. For a 26-, 52-, 106-, 242-, 484-, and 996-tone single RU, the segment parser is bypassed.

In an example, no dual carrier modulation (DCM) is used. In an example, let the number of coded bits per symbol of one spatial stream coming out of the stream parser be N_{CBPSS,u} bits for a given user u. These bits are further divided into L blocks by the segment parser, with N_{CBPSS,l,u} bits for block l=0, 1, . . . , L−1 respectively such that

$${\sum }_{l = 0}^{L - 1} {N}_{CBPSS , l , u} = {N}_{CBPSS , u} .$$

Here L=2 is the number of RUs in the MRUs; each RU is a block. Let the number of coded bits per subcarrier per spatial stream be N_{BPSCS,l,u} for the lₜₕ block. The values of L and N_{CBPSS,l,u} are given in Table 1 for various MRU cases. The round robin segment parser assigns input bits to the L=2 blocks: m₀ consecutive bits are assigned to block 0, m₁ consecutive bits are assigned to block 1, and this process is repeated in rounds or iterations until one block first gets all the bits it needs; the remaining input bits are assigned to the block with a non-zero number of leftover bits. m₀ and m₁ are proportional or approximately proportional to the number of occupied tones and the modulation order used in the corresponding RU. Depending on if BPSK modulation is used in which of the two frequency blocks or RUs, the parameters such as m₀, m₁, and the number of leftover bits for RU block l (denoted by N_{leftover,l}, l=0, 1) are defined in Table 2, Table 3, and Table 4. Note that a selection criteria of m₀ and m₁ in Table 2, Table 3, and Table 4 is to minimize the number of leftover bits in both RU blocks.

TABLE 1
Values of L and N_{CBPSS, l, u} for UEQM over RUs of MRUs
within 80 MHz frequency subblock when DCM is not used

| | RU order (low to | | | |
|---|---|---|---|---|
| MRU | high frequency) | L | N_{CBPSS, 0, u} | N_{CBPSS, 1, u} |
| 52 + 26 | 26 + 52 | 2 | 24 × N_{BPSCS, 0, u} | 48 × N_{BPSCS, 1, u} |
| | 52 + 26 | | 48 × N_{BPSCS, 0, u} | 24 × N_{BPSCS, 1, u} |
| 106 + 26 | 106 + 26 | | 102 × N_{BPSCS, 0, u} | 24 × N_{BPSCS, 1, u} |
| | 26 + 106 | | 24 × N_{BPSCS, 0, u} | 102 × N_{BPSCS, 1, u} |
| 484 + 242 | 242 + 484 | | 234 × N_{BPSCS, 0, u} | 468 × N_{BPSCS, 1, u} |
| | 484 + 242 | | 468 × N_{BPSCS, 0, u} | 234 × N_{BPSCS, 1, u} |

TABLE 2
Segment parser parameters for UEQM over RUs of MRUs
within 80 MHz frequency subblock when DCM is not used,
for the cases that the modulation orders on both RUs
are not BPSK, or both RUs have BPSK modulation

| | RU order | | | | | |
|---|---|---|---|---|---|---|
| | (low to | | | | | |
| | high | | | | | |
| MRU | frequency) | L | m₀ | m₁ | N_{leftover, 0} | N_{leftover, 1} |
| 52 + 26 | 26 + 52 | 2 | s₀ | 2s₁ | 0 | 0 |
| | 52 + 26 | | 2s₀ | s₁ | 0 | 0 |
| 106 + 26 | 26 + 106 | | s₀ | 4s₁ | 0 | 6 × N_{BPSCS, 1, u} |
| | 106 + 26 | | 4s₀ | s₁ | 6 × N_{BPSCS, 0, u} | 0 |
| 484 + 242 | 242 + 484 | | s₀ | 2s₁ | 0 | 0 |
| | 484 + 242 | | 2s₀ | s₁ | 0 | 0 |

TABLE 3
Segment parser parameters for UEQM over RUs of MRUs within
80 MHz frequency subblock when DCM is not used, for the cases
that the modulation order on the first RU is BPSK while the
second RU has a modulation order higher than BPSK

| | RU order | | | | | |
|---|---|---|---|---|---|---|
| | (low to | | | | | |
| | high | | | | | |
| MRU | frequency) | L | m₀ | m₁ | N_{leftover, 0} | N_{leftover, 1} |
| 52 + 26 | 26 + 52 | 2 | s₀ | 4s₁ | 0 | 0 |
| | 52 + 26 | | s₀ | s₁ | 0 | 0 |
| 106 + 26 | 26 + 106 | | s₀ | 8s₁ | 0 | 6 × N_{BPSCS, 1, u} |
| | 106 + 26 | | 2s₀ | s₁ | 6 × N_{BPSCS, 0, u} | 0 |
| 484 + 242 | 242 + 484 | | s₀ | 4s₁ | 0 | 0 |
| | 484 + 242 | | s₀ | s₁ | 0 | 0 |

TABLE 4
Segment parser parameters for UEQM over RUs of MRUs within
80 MHz frequency subblock when DCM is not used, for the
cases that the modulation order on the first RU is higher
than BPSK while the second RU has BPSK modulation

| | RU order | | | | | |
|---|---|---|---|---|---|---|
| | (low to | | | | | |
| | high | | | | | |
| MRU | frequency) | L | m₀ | m₁ | N_{leftover, 0} | N_{leftover, 1} |
| 52 + 26 | 26 + 52 | 2 | s₀ | s₁ | 0 | 0 |
| | 52 + 26 | | 4s₀ | s₁ | 0 | 0 |
| 106 + 26 | 26 + 106 | | s₀ | 2s₁ | 0 | 6 × N_{BPSCS, 1, u} |
| | 106 + 26 | | 8s₀ | s₁ | 6 × N_{BPSCS, 0, u} | 0 |
| 484 + 242 | 242 + 484 | | s₀ | s₁ | 0 | 0 |
| | 484 + 242 | | 4s₀ | s₁ | 0 | 0 |

Denoting the input bit sequence to the segment parser for user u as {x_{m,u}} and the output bit sequence of RU block I for user u as {y_{k,l,u}}, the mapping between the input and output sequences before reaching the leftover bits is given by

$${y}_{k , l , u} = {x}_{m , u} \qquad ( 6 )$$

$$m = ( {\sum }_{i = 0}^{L - 1} {m}_{i} ) ⌊ \frac{k}{{m}_{l}} ⌋ + {\sum }_{i = 0}^{l - 1} {m}_{i} + ( k mod {m}_{l} )$$

where y_{k,l,u} is bit k of RU block/for user u. k=0, 1, . . . , N_{CBPSS,l,u}−N_{leftover,l}−1. l is the RU block index in an 80 MHz frequency subblock, l=0, 1, . . . L−1. L is the number of RU blocks. L=2 for 52+26-, 106+26-, 484+242-tone MRUs in an 80 MHz frequency subblock. u is the user index, u=0, 1, . . . . Nᵤₛₑᵣ−1. x_{m,u} is bit m of a block of

$${N}_{CBPSS , u} = {\sum }_{i = 0}^{L - 1} {N}_{CBPSS , i , u}$$

input bits to the segment parser and m=0, 1, . . . , N_{CBPSS,u}−1. mᵢ is the number of consecutive input bits assigned to block i for each round of the round robin segment parser and i=0, 1, . . . , L−1. Values of mᵢ are given in Table 2, Table 3, and Table 4. The values are proportional or approximately proportional to the number of occupied data subcarriers and the number of coded bits per subcarrier per spatial stream N_{BPSCS,l,u} in each RU block. mᵢ is the number of consecutive input bits assigned to block l for each round of the round robin segment parser.

$${\sum }_{i = 0}^{l - 1} {m}_{i} = 0$$

for [symbol] =0. Note that

$${s}_{l} = max ( 1 , \frac{{N}_{BPSCS , l , u}}{2} )$$

### In Table 2, Table 3, and Table 4.

For leftover bits, the mapping between the input and output bit sequences of the segment parser is given by

$${y}_{k , l , u} = {x}_{m , u} \qquad ( 7 )$$

$$m = ( {\sum }_{i = 0}^{L - 1} {m}_{i} ) ⌊ \frac{{N}_{CBPSS , {l}_{0} , u}}{{m}_{{l}_{0}}} ⌋ + ( {\sum }_{i = 0 , i \neq {l}_{0}}^{L - 1} {m}_{i} ) ⌊ \frac{{k}^{′}}{{m}_{l}} ⌋ + {\sum }_{i = 0 , i \neq {l}_{0}}^{L - 1} {m}_{i} + ( k mod {m}_{l} )$$

$$where$$

$$k = ( {N}_{CBPSS , l , u} - {N}_{leftover , l} ) , ( {N}_{CBPSS , l , u} - {N}_{leftover , l} ) + 1 , … , {N}_{CBPSS , l , u} - 1.$$

$${k}^{′} = k - ( {N}_{CBPSS , l , u} - {N}_{leftover , l} ) .$$

[symbol] ₀ is the RU block index with zero leftover bits, i.e., N_{leftover,l}_{₀}=0.

$${\sum }_{i = 0 , i \neq {l}_{0}}^{l - 1} {m}_{i} = 0 for RU block l = 0 .$$

In another example, DCM is used. For MRUs with size equal to or smaller than 996 tones, BPSK-DCM is applied to the bottom- and top-half tones of the MRU. That is, if all the usable data tones in the MRU are indexed from 0 to N_{SD}−1, bit sequences are mapped to a pair of symbols (dₖ, d_{k+N}_{_{SD}}/2) on a tone pair (k, k+N_{SD}/2), where

$$k = 0 , 1 , … , \frac{{N}_{S D}}{2} - 1$$

and d_{k+N}_{_{SD}}_{/2} is a duplicate of dₖ with phase rotation. For example, for a 52+26-tone MRU that has a 26-tone RU at the lower frequency, the input bits occupy the 24 data tones of the 26-tone RU and the first 12 data tones of the 52-tone RU, and these 36 tones are duplicated on the remaining 36 data tones of the 52-tone RU for DCM.

In this case, the segment parser may be bypassed when DCM is used. In another example, Equations (6) and (7) apply for the mapping between the input and output sequences of the segment parser, only with the updated definitions of L, N_{CBPSS,l,u}, mₗ and N_{leftover,l} (the number of leftover bits for RU block l) in Table 5.

TABLE 5
Segment parser parameters for UEQM over RUs of MRUs
within 80 MHz frequency subblock when DCM is used

| | RU order | | | | | | | |
|---|---|---|---|---|---|---|---|---|
| | (low to | | | | | | | |
| | high | | | | | | | |
| MRU | frequency) | L | N_{CBPSS, 0, u} | N_{CBPSS, 1, u} | m₀ | m₁ | N_{leftover, 0} | N_{leftover, 1} |
| 52 + 26 | 26 + 52 | 2 | 24 | 12 | 2 | 1 | 0 | 0 |
| | 52 + 26 | | 36 | 0 | 1 | 0 | 0 | 0 |
| 106 + 26 | 26 + 106 | | 24 | 39 | 2 | 3 | 0 | 3 |
| | 106 + 26 | | 63 | 0 | 1 | 0 | 0 | 0 |
| 484 + 242 | 242 + 484 | | 234 | 117 | 2 | 1 | 0 | 0 |
| | 484 + 242 | | 351 | 0 | 1 | 0 | 0 | 0 |

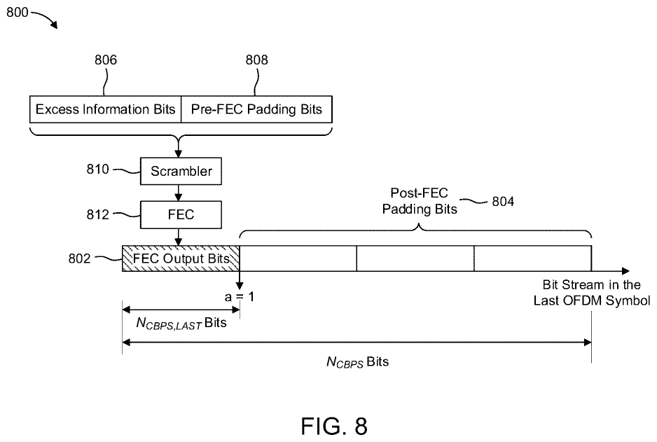

Example procedures address the impact of UEQM on the PPDU padding process. FIG. 8 is a frame format diagram illustrating an example PPDU 800 format illustrating the EHT PPDU bit padding process. As illustrated in FIG. 8, a two-step padding process is applied to an EHT PPDU 800. A pre-FEC padding process, including application of pre-FEC MAC and pre-FEC PHY padding bits 808 is applied before conducting scrambling in scrambler 810 and FEC coding 812 to generate FEC output bits 802, and application of post-FEC PHY padding bits 804 is applied on the FEC encoded bits. The same padding process may apply to a UHR PPDU 800 with UEQM across spatial streams, or UEQM across both spatial streams and different frequency segments. The number of bits that can be transmitted in the last OFDM symbol is divided into four approximately equal portions. The pre-FEC padding factor a=1 corresponds to the first portion; a=2 corresponds to the first two portions; a=3 corresponds to the first three portions; and a=4 corresponds to the whole symbol. A number of pre-FEC padding bits 808 are concatenated to the excess information bits 806 of the last OFDM symbol, then this combined bit sequence is fed into a FEC coder 812. The number of the pre-FEC padding bits 808 is selected such that the number of the FEC output bits 802 should be covered by the portions corresponding to a minimal pre-FEC padding factor a. The remaining bits needed by the last OFDM symbol are called post-FEC padding bits 804. In the example FIG. 8, the pre- and post-FEC padding process uses a pre-FEC padding factor a=1.

The main impact of UEQM on the padding process is to consider the different number of bits carried on different spatial streams and subcarriers in the calculation of the parameters used in the padding process.

In the case of UEQM over spatial streams only, the parameters affected include any of the following parameters. For each user, the number of coded bits per OFDM symbol N_{CBPS} is defined as

$${\sum }_{i = 0}^{{N}_{SD} - 1} {\sum }_{j = 0}^{{N}_{ss} - 1} {N}_{BPSCS , i , j} ,$$

where N_{SD} is the number of effective data tones in an OFDM symbol, Nₛₛ is the number of spatial streams, N_{BPSCS,i,j} is the number of coded bits on spatial stream j of subcarrier i. That is a general expression accounting for all cases of equal modulation (EQM) and UEQM. For example, EQM assumes one single value N_{BPSCS} as the number of coded bits per subcarrier per spatial stream and N_{CBPS}=N_{SD}·Nₛₛ·N_{BPSCS}. For UEQM over spatial streams only, we have N_{BPSCS,j} as the number of coded bits on spatial stream j per subcarrier, and

$${N}_{CBPS} = {N}_{SD} {\sum }_{j = 0}^{{N}_{ss} - 1} {N}_{BPSCS , j} .$$

The number of data bits per OFDM symbol N_{DBPS} is correspondingly defined as N_{CBPS}·R, where R is the coding rate. Similarly, N_{CBPS,short} used to calculate the pre-FEC padding factor a is modified to

$${N}_{CBPS , short} = {N}_{SD , short} \cdot {\sum }_{j = 0}^{{N}_{ss} - 1} {N}_{BPSCS , j} ,$$

where N_{SD,short} values used for non-DCM EHT-MCSs are approximately ¼ of N_{SD}. The N_{SD,short} values used for EHT PPDUs can be used in this case. Correspondingly, N_{DBPS,short}=N_{CBPS,short}·R.

In the case of UEQM over frequency only, the parameters affected include any of the following parameters. For each user, the number of coded bits per OFDM symbol N_{CBPS} is expressed as

$${N}_{CBPS} = {N}_{ss} \cdot {\sum }_{i = 0}^{{N}_{SD} - 1} {N}_{BPSCS , i} ,$$

where N_{SD} is the number of effective data tones in an OFDM symbol, Nₛₛ is the number of spatial streams, N_{BPSCS,i} is the number of coded bits per spatial stream on subcarrier i. The number of data bits per OFDM symbol N_{DBPS} is correspondingly defined as N_{CBPS}·R, where R is the coding rate. The calculation of the pre-FEC padding factor a on the last OFDM symbol is based on dividing N_{CBPS}, the maximum number of bits that could be transmitted on an OFDM symbol, into four approximately equal portions, and finding the minimum factor a such as the FEC output bits of the information bits and pre-FEC padding bits on the last OFDM symbol can fall into the portions determined by a. The size of each such portion (or at least the first three portions) is denoted by N_{CBPS,short}. The calculation of N_{CBPS,short} for this UEQM over frequency only case cannot be based on N_{SD,short} values used previously for EQM or UEQM over spatial streams only. One way to define N_{CBPS,short} is to let it be approximately ¼ of N_{CBPS}, i.e., N_{CBPS,short}=┌N_{CBPS}/4┐. Correspondingly, N_{DBPS,short}=N_{CBPS,short}·R.

In the case of UEQM over both spatial streams and frequency, the parameters affected include any of the following parameters. For each user, the number of coded bits per OFDM symbol N_{CBPS} is expressed as

$${N}_{CBPS} = {\sum }_{i = 0}^{{N}_{SD} - 1} {\sum }_{j = 0}^{{N}_{ss} - 1} {N}_{BPSCS , i , j} ,$$

where N_{SD} is the number of effective data tones in an OFDM symbol, Nₛₛ is the number of spatial streams, N_{BPSCS,i,j} is the number of coded bits on spatial stream j of subcarrier i. The number of data bits per OFDM symbol N_{DBPS} is correspondingly defined as N_{CBPS}·R, where R is the coding rate. N_{CBPS,short}=┌N_{CBPS}/4┐. Correspondingly, N_{DBPS,short}=N_{CBPS,short}·R.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A station (STA) comprising:
a transceiver; and
a processor,
wherein the transceiver and processor are configured to:
determine, for each spatial stream of a plurality of spatial streams, an associated modulation order, wherein a first spatial stream of the plurality of spatial streams has an associated modulation order with a one-dimensional (1D) constellation and a second spatial stream of the plurality of spatial streams has an associated modulation order with a two-dimensional (2D) constellation; and
parse a bit sequence corresponding to an OFDM symbol into the plurality of spatial streams by iteratively allocating, in round robin order for a number of iterations, a respective number of consecutive bits of the OFDM symbol to each of the plurality of spatial streams according to the associated modulation orders and not allocating any bits to the first spatial stream in every second iteration of the round robin order.

2. The STA of claim 1, wherein the transceiver and processor are further configured to:
transmit the plurality of spatial streams in a plurality of frequency subblocks associated with the plurality of spatial streams.

3. The STA of claim 2, wherein the plurality of frequency subblocks comprise one or more resource units (RUs), and the one or more RUs comprises data tones, wherein the bits allocated to each of the plurality of the spatial streams are mapped to constellation point sequences on the data tones.

4. The STA of claim 2, wherein the plurality of frequency subblocks are 20 MHz, 40 MHz, 80 MHz, 160 MHz, or 320 MHz wide.

5. The STA of claim 1, wherein the associated modulation order of the first spatial stream of the plurality of spatial streams is binary phase shift keying (BPSK) and the 1D constellation is on a real axis in a complex plane.

6. The STA of claim 1, wherein the associated modulation order of the second spatial stream of the plurality of spatial streams is one of: quadrature phase sift keying (QPSK), 16-quadrature amplitude modulation (16-QAM), 64-QAM, 256-QAM, 1024-QAM, or 4096-QAM.

7. The STA of claim 1, wherein the 2D constellation of the associated modulation order of the second spatial stream of the plurality of spatial streams has complex constellation points with a real component and an imaginary component.

8. The STA of claim 1, wherein at least one other spatial stream of the plurality of spatial streams has an associated modulation order with a 1D constellation, wherein the iterative allocation does not allocate any bits to the at least one other spatial stream in every second iteration of the round robin order.

9. The STA of claim 1, wherein the bit sequence {eᵢ}, i=0, 1, . . . , N_{CBPS}−1 has N_{CBPS} bits, Nₛₛ is the number of spatial streams in the plurality of spatial streams iₛₛ=0, 1, . . . , Nₛₛ−1, N_{CBPSS,i}_{ₛₛ} is the number of coded bits of the OFDM symbol for spatial stream iₛₛ of the plurality of spatial streams, sᵢ_{ₛₛ} is the number of consecutive bits allocated to spatial stream iₛₛ for iₛₛ=0, 1, . . . , Nₛₛ−1, and wherein the bit sequence is parsed into the plurality of bit streams so that bit with index i of the bit sequence {eᵢ} is assigned to bit with index j of output bit sequence {x_{j,i}_{ₛₛ}} of spatial stream iₛₛ according to x_{j,i}_{ₛₛ}=eᵢ where
$$i = \{ \begin{matrix}{S}^{″} \cdot ⌊ \frac{j}{{N}_{BPSCS , {i}_{ss}}} ⌋ + {\sum }_{k = 0}^{{i}_{ss} - 1} {s}_{k} + j mod {s}_{{i}_{ss}} , if ( j mod {N}_{BPSCS , {i}_{ss}} ) < {s}_{{i}_{ss}} \\ {S}^{″} \cdot ⌊ \frac{j}{{N}_{BPSCS , {i}_{ss}}} ⌋ + S + {\sum }_{k = 0}^{{i}_{ss} - 1} {s}_{k} \cdot I ( {N}_{BPSCS , {i}_{ss}} > 1 ) + j mod {s}_{{i}_{ss}} , if ( j mod {N}_{BPSCS , {i}_{ss}} ) \geq {s}_{{i}_{ss}}\end{matrix}$$
$$for {i}_{ss} = 0 , 1 , … , {N}_{ss} - 1$$
$$i = 0 , 1 , … , {N}_{CBPS} - 1 ,$$
$$j = 0 , 1 , … , {N}_{CBPSS , {i}_{ss}} - 1 ,$$
$$where {S}^{″} = {\sum }_{{i}_{ss} = 0}^{{N}_{ss} - 1} {N}_{BPSCS , {i}_{ss}} , S = {\sum }_{{i}_{ss} = 0}^{{N}_{ss} - 1} {s}_{{i}_{ss}} , and I ( {N}_{BPSCS , {i}_{ss}} > 1 )$$
is an indicator function of whether or not the modulation order on spatial stream iₛₛ is larger than BPSK.

10. The STA of claim 1 configured as an 802.11bn Ultra High Reliability (UHR) STA.

11. A method performed by a station (STA), the method comprising:
determining, for each spatial stream of a plurality of spatial streams, an associated modulation order, wherein a first spatial stream of the plurality of spatial streams has an associated modulation order with a one-dimensional (1D) constellation and a second spatial stream of the plurality of spatial streams has an associated modulation order with a two-dimensional (2D) constellation; and
parsing a bit sequence corresponding to an OFDM symbol into the plurality of spatial streams by iteratively allocating, in round robin order for a number of iterations, a respective number of consecutive bits of the OFDM symbol to each of the plurality of spatial streams according to the associated modulation orders and not allocating any bits to the first spatial stream in every second iteration of the round robin order.

12. The method of claim 11, further comprising:
transmitting the plurality of spatial streams in a plurality of frequency subblocks associated with the plurality of spatial streams.

13. The method of claim 12, wherein the plurality of frequency subblocks comprise one or more resource units (RUs), and the one or more RUs comprises data tones, wherein the bits allocated to each of the plurality of the spatial streams are mapped to constellation point sequences on the data tones.

14. The method of claim 12, wherein the plurality of frequency subblocks are 20 MHz, 40 MHz, 80 MHz, 160 MHz, or 320 MHz wide.

15. The method of claim 11, wherein the associated modulation order of the first spatial stream of the plurality of spatial streams is binary phase shift keying (BPSK) and the 1D constellation is on a real axis in a complex plane.

16. The method of claim 11, wherein the associated modulation order of the second spatial stream of the plurality of spatial streams is one of: quadrature phase sift keying (QPSK), 16-quadrature amplitude modulation (16-QAM), 64-QAM, 256-QAM, 1024-QAM, or 4096-QAM.

17. The method of claim 11, wherein the 2D constellation of the associated modulation order of the second spatial stream of the plurality of spatial streams has complex constellation points with a real component and an imaginary component.

18. The method of claim 11, wherein at least one other spatial stream of the plurality of spatial streams has an associated modulation order with a 1D constellation, wherein the iteratively allocating does not allocate any bits to the at least one other spatial stream in every second iteration of the round robin order.

19. The method of claim 11, wherein the bit sequence {eᵢ}, i=0, 1, . . . , N_{CBPS}−1 has N_{CBPS} bits, Nₛₛ is the number of spatial streams in the plurality of spatial streams iₛₛ=0, 1, . . . , Nₛₛ−1, N_{CBPSS,i}_{ₛₛ} is the number of coded bits of the OFDM symbol for spatial stream iₛₛ of the plurality of spatial streams, sᵢ_{ₛₛ} is the number of consecutive bits allocated to spatial stream iₛₛ for iₛₛ=0, 1, . . . , Nₛₛ−1, and wherein the bit sequence is parsed into the plurality of bit streams so that bit with index i of the bit sequence {eᵢ} is assigned to bit with index j of output bit sequence {x_{j,i}_{ₛₛ}} of spatial stream iₛₛ according to x_{j,i}_{ₛₛ}=eᵢ where
$$i = \{ \begin{matrix}{S}^{″} \cdot ⌊ \frac{j}{{N}_{BPSCS , {i}_{ss}}} ⌋ + {\sum }_{k = 0}^{{i}_{ss} - 1} {s}_{k} + j mod {s}_{{i}_{ss}} , if ( j mod {N}_{BPSCS , {i}_{ss}} ) < {s}_{{i}_{ss}} \\ {S}^{″} \cdot ⌊ \frac{j}{{N}_{BPSCS , {i}_{ss}}} ⌋ + S + {\sum }_{k = 0}^{{i}_{ss} - 1} {s}_{k} \cdot I ( {N}_{BPSCS , {i}_{ss}} > 1 ) + j mod {s}_{{i}_{ss}} , if ( j mod {N}_{BPSCS , {i}_{ss}} ) \geq {s}_{{i}_{ss}}\end{matrix}$$
$$for {i}_{ss} = 0 , 1 , … , {N}_{ss} - 1$$
$$i = 0 , 1 , … , {N}_{CBPS} - 1 ,$$
$$j = 0 , 1 , … , {N}_{CBPSS , {i}_{ss}} - 1 ,$$
$$where {S}^{″} = {\sum }_{{i}_{ss} = 0}^{{N}_{ss} - 1} {N}_{BPSCS , {i}_{ss}} , S = {\sum }_{{i}_{ss} = 0}^{{N}_{ss} - 1} {s}_{{i}_{ss}} , and I ( {N}_{BPSCS , {i}_{ss}} > 1 )$$
is an indicator function of whether or not the modulation order on spatial stream iₛₛ is larger than BPSK.

20. The method of claim 11, wherein the STA is configured as an 802.11bn Ultra High Reliability (UHR) STA.
